(19) United States
(12) Patent Application Publication
(10) Pub. No.: US 2016/0086179 A1
(43) Pub. Date: Mar. 24, 2016

(54) Shared Electronic Wallet With Permissions

(71) Applicant: Transfer To Inc., San Francisco, CA (US)

(72) Inventor: Eric Barbier, San Francisco, CA (US)

(21) Appl. No.: 14/493,390

(22) Filed: Sep. 23, 2014

(51) Int. Cl. G06Q 20/40; G06Q 20/36

(52) U.S. Cl. CPC G06Q 20/405; G06Q 20/36

(57) ABSTRACT

A payment system and method for processing purchases made by a dependent recipient and funded by a payor are provided. The payment system stores conditions set by a payor, and the conditions govern use of the payor's money by the recipient. Purchase transactions within the payment system are initiated by the recipient and approved or rejected by the administrator of the payment system prior to merchant involvement in the process. The administrator approves the purchase request only when the conditions set by the payor have been satisfied, and the merchant is notified of the purchase and paid in response to approval of the purchase request. The administrator rejects the purchase request if the payor conditions are not met, and the administrator notifies the recipient if the purchase request is rejected.

### FIELD OF THE INVENTION

The present invention generally relates to electronic payments, and more specifically to electronic payments funded by a payor for use by a different purchaser.

### BACKGROUND OF THE DISCLOSURE

Generally, people purchase items and services for themselves or others in a variety of ways. A purchaser may, for example, use cash, write a check, or use a credit card to pay for an item or a service. In many situations, a person may pay for items or services required by another person, such as when the other person is financially unable to pay for his or her own items or in the case of a gift. This type of arrangement is common in the case of a parent and a child, for example, or in the case of dependent family members or friends.

When dependent family members or friends live geographically distant from a person who is financially supporting them, payments arrangements are often much more difficult for a number of reasons. For one, exchange rates between different countries fluctuate, so the amount of money needed by a dependent is not easy to calculate. Additionally, sending cash or checks to a dependent via a mail service may take several days, so the financially dependent person may not receive urgently needed funds on time. Money and other items sent by mail are also subject to theft and loss.

As a result, financial assistance to geographically distant dependents is usually provided in the form of a wire transfer. The dependent recipient of the funds may receive wired payments in the form of cash or a bank deposit. Alternatively, a person may provide a dependent with a pre-paid credit or debit card. Both of these options, however, require an existing financial infrastructure that is not available in many countries. Dependents in such countries may be unable to establish a bank account, and merchants and service providers in such countries may not accept debit or credit card payments.

An additional issue is that money provided to another person is not always used for the purpose intended by the financial provider. One way to address this issue is for the financial provider to directly pay for the goods or services needed by the dependent person. This isn't practical, however, when the person providing the money lives far away from the financially dependent person. Even when both parties live near one another, making purchases on behalf of another person can be time-consuming and prone to error. As a result, it is often preferable for one person to send money to another person, even given the risk that the money will be spent in ways that the financial provider would not condone.

Thus, there exists a need for a payment system in which a financial provider can easily, safely, and quickly transfer funds to a dependent located in a geographical location where financial infrastructures, such as banking and credit card infrastructures, may be absent. Additionally, there exists a need for a payment system in which the financial provider can ensure that provided funds are used by the dependent in approved ways.

Furthermore, other desirable features and characteristics will become apparent from the subsequent detailed description and the appended claims, taken in conjunction with the accompanying drawings and this background of the disclosure.

### SUMMARY OF THE INVENTION

According to the Detailed Description, a payment system is provided for processing a purchase that a recipient has requested and that, if approved, is funded by a payor. The payment system includes a memory for storing account balance information associated with an account funded by the payor and purchase conditions set by the payor and a communication device for receiving a purchase request from the recipient, wherein the purchase request is indicative of the purchase that the recipient desires to make. The payment system further includes a processor coupled to the memory and the communication device for determining whether the purchase request meets the purchase conditions set by the payor and for generating a purchase approval notification when the purchase request satisfies the purchase conditions. The communication device transmits the purchase approval notification to the recipient and, subsequent to determining that the purchase request meets the purchase conditions, communicates with a merchant associated with the purchase request to notify the merchant of the purchase and to authorize payment to the merchant for the purchase.

There is further provided a method for processing, within a payment system, a purchase requested by a recipient and funded by a payor. The payment system includes a memory for storing account information associated with an account funded by the payor, a communication device for transmitting and receiving notifications associated with the purchase, and a processor for approving or rejecting the use of payor funds in association with the purchase. The method includes the step of receiving, from the payor, the purchase conditions and storing them in the memory. The method further includes the steps of the communication device receiving a purchase request from a recipient device, the processor comparing information included in the purchase request with the purchase conditions stored in the memory, and the processor determining whether the purchase request satisfies the purchase conditions. The communication device transmits a purchase approval notification to the recipient device in response to the processor determining that the purchase request satisfies the purchase conditions and notifies a merchant associated with the purchase request of the purchase in response to the processor determining that the purchase request satisfies the purchase conditions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is a block diagram of a payment system in accordance with the present invention.

FIG. 2 is a flowchart depicting processes related to a payor's use of the payment system of FIG. 1 in accordance with the present invention.

FIG. 3 is a flowchart depicting processes related to a recipient's use of the payment system of FIG. 1 in accordance with the present invention.

FIG. 4 is a flowchart depicting registration and payment transaction processes performed by the payment system 100 of FIG. 1 in accordance with the present invention.

FIG. 5 is a flowchart depicting merchant process occurring within the payment system of FIG. 1 in accordance with the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention. In the following description, a person or user may be referred to using the terms “he,” “him,” and “his” for convenience only, and not by way of limitation. It is understood that such references are inclusive of both genders and not intended to limit the application of this invention in any way.

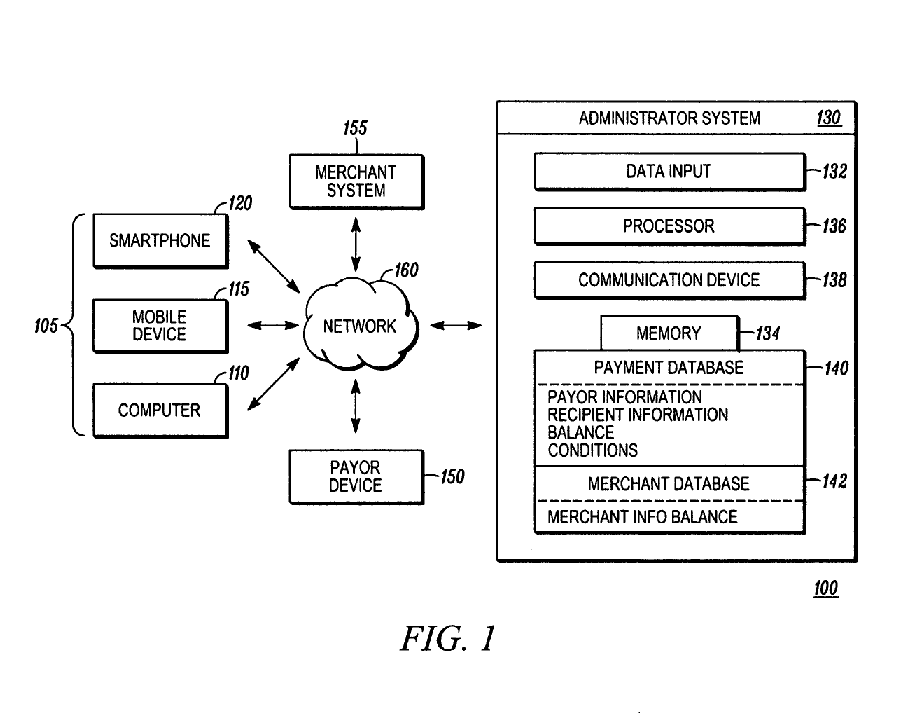

Referring to FIG. 1, a block diagram illustrates a payment system 100 in accordance with an embodiment of the present invention. The system 100 includes at least one device 105 that may be used by a person to facilitate purchases. Such a device 105 could be a computer 110, a telephone (not shown), a smart phone 120, or another mobile device 115, such as an iPad or tablet device. The system 100 further includes an administrator system 130 for faciliting payments within the payment system 100. Generally, the administrator system 130 includes a data input device 132 for receiving payment and transaction information, a memory 134 for storing the information, and a communication device 136 for receiving and transmitting payment instructions and information. It will be appreciated that the data input device 132 could be a part of the communication device 136, depending upon how information is received by the administrator system 130.

The device 105 used by the purchaser is coupled to the administrator system 130 by a network 160, which may be a private communication network, a local area network (LAN), a wide area network (WAN), the Internet, or any other network that permits communication between different systems or devices. Within the payment system 100, a purchaser may use his or her device 105 to purchase services or items or to otherwise access available funds that have been provided by another person, hereinafter referred to as a sender, a payor, or a financial provider. The payor, in accordance with an embodiment of the present invention, provides to the administrator funds that are designated for conditional use by the recipient/purchaser. The payor may, for example, set up an account with the administrator by depositing cash, depositing a check, providing access to a credit card account, or by depositing money in any other way acceptable to the administrator. The administrator may hold funds in a physical location located on its premises, deposit funds in a bank account, deposit funds with a preferred merchant, or simply access another payor account or invoice the payor as necessary.

According to the present invention, the payment system 100 provides means for a payor or financial supporter to provide funds, via the administrator, for use by another person, hereinafter referred to as a dependent, purchaser, or recipient. The payor may conveniently set conditions that regulate the recipient's use of the funds provided by the payor. By way of example, the payor may designate a type of item or service that may be purchased by the recipient using the payor's funds. Alternatively, the use of the funds may be restricted to a particular merchant or merchants, specific goods or services, a date or date range, or certain amounts or price ranges. Conditions could also be set to govern, limit, or entirely prohibit cash withdrawals from the payor account by the recipient.

Referring again to FIG. 1, the payor may use a device 150, such as a computer, a telephone, a mobile communication device, or other network device, to set up an account with the administrator, to deposit funds, to designate one or more recipients who may access the funds, and to set conditions regulating the use of the funds. Additionally, such device 150 may be used to communicate with the administrator system 130 regarding the payor's account over the network 160. As mentioned hereinabove, the payor may instead communicate directly with an administrator representative, such as by meeting a representative at a branch location. Merchant systems 155 may also be coupled to the administrator system 130 over the network 160.

The administrator system 130 includes a processor 136 for receiving and transmitting information from and to, respectively, a communication device 138, which communicates with payors, recipients, merchants, and other systems and devices coupled to the network 160. The processor 136 is coupled to the memory 134 for storing payment information in a payment database 140. The payment information preferably includes the payor's account information, such as payor identification, password information, payor contact information, recipient identification, recipient password information, recipient contact information, the account balance available to the recipient(s), and usage conditions and/or permissions associated with each recipient. The memory 134 may also store merchant information 142, which will be discussed in greater detail hereinbelow.

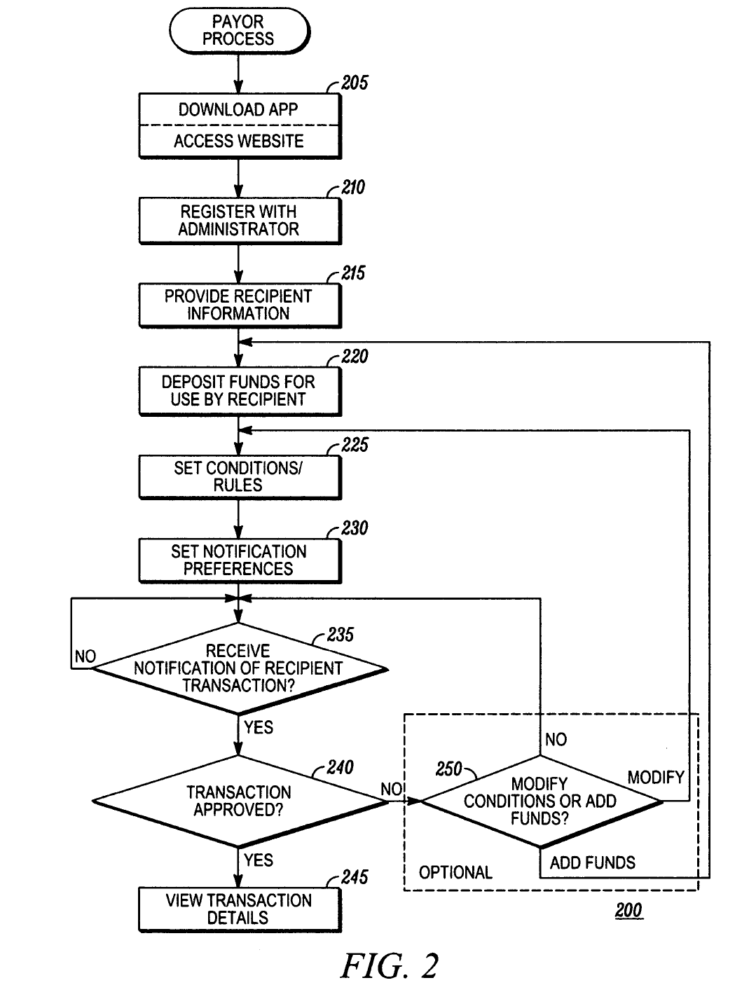

FIG. 2 is a flowchart illustrating a process by which a payor (the person providing funds for a recipient or dependent) may establish and maintain funds within the payment system 100. The first step for a payor is to set up an account with the administrator, and this could be done a number of ways. By way of example, the payor could establish an account at a physical location, if such is maintained by the administrator. In accordance with an embodiment of the present invention, the payor may, at step 205, download or install an app onto a mobile communication device 150 (FIG. 1), such as a smartphone, or access an administrator website from a computer or other network device. Next, at step 210, the payor registers with the administrator to create an account. The payor preferably provides identification information and a password to secure and limit access to his account.

The payor then provides, at step 215, recipient information to identify the person or persons for whom he intends to provide funds. A recipient may be identified by name, mobile number, email address or any other identification information that serves to accurately and uniquely identify the person who is authorized to access the funds provided by the payor. At this point, the payor may also establish a password for the recipient. The password may be permanent or temporary, in which case the recipient may subsequently change the password if permitted by the payor. It will be appreciated that the payor may provide funds for multiple recipients, in which case the payor provides information associated with each recipient to the administrator.

At step 220, the payor provides funds that may be used by the recipient. The payor may grant permission for the funds to be withdrawn from a bank account or may pay via credit card or debit card. Alternatively, the payor may deposit funds by check or any other method that is acceptable to the administrator, or the administrator may optionally invoice the payor for disbursed funds in the event that the funds are not advanced by the payor.

In accordance with the payment system 100, at step 225, the payor may also conveniently set conditions that are to be met in order for the recipient to use the funds. For instance, the payor may designate that the funds can be disbursed only to specific merchants or categories of merchants, such as grocery stores, utilities, or mobile service providers. The payor may also approve types of merchandise or services or even specific items, which could be identified by QR (Quick Response) codes, other bar codes, serial numbers, or other identifiers. Additionally, the payor may set a date range during which the funds may be used by the recipient, a cap on the funds available to the recipient, and any other conditions. It will be appreciated that the payor may also make funds available to a recipient with no conditions, in which case all purchases not exceeding the account balance would be approved by the administrator system 130.

It can be seen that the payment system 100 provides a secure method for ensuring that a dependent recipient uses funds provided by the payor only for intended purposes. In this manner, the system 100 of the present embodiment prevents the funds from being squandered, lost, or stolen. Additionally, the payment system 100 can be utilized in situations and locations in which conventional banking and credit card infrastructures are sparse or nonexistent, as will be described in greater detail below.

Referring back to FIG. 2, at step 230, the payor may set notifications associated with his account. The payor may, for instance, choose to be notified, at step 235, by the administrator once the recipient has registered with the administrator, when the recipient has made a purchase or withdrawn funds from the account, when funds are low in the account, and/or when the recipient has attempted to make a purchase that is not approved according to the conditions set by the payor. If, at step 240, a notification is received indicating that an approved transaction has been processed, the payor may, at step 245, view the transaction details, perhaps by viewing a notification text or email sent by the administrator system 130, selecting to view details within an app installed on the recipient communication device 105, or navigating to an administrator website to view the transaction details.

During the payment approval process, the payor may optionally recieve a notification from the administrator for another reason, such as notifying the payor that the recipient has attempted to make an unapproved purchase or alerting the payor that funds are low or depleted entirely. If the payment system 100 is structured to provide such notifications, the payor may, at step 250, deposit additional funds for use by the recipient (in the case of a low fund notification) or choose to modify the conditions so that the recipient may make the purchase. Such modification could be a one-time exception to the conditions, or the conditions could be modified for some or all future transactions, as selected by the payor. It is envisioned, however, that the payment conditions and rules within the payment system 100 are preset and automatically applied so that the approval process requires no additional input by the payor and so that the recipient receives notification of purchase approval/rejection in a timely manner.

According to an embodiment of the present invention, the payment system 100 receives purchase requests from the recipient device 105 and communicates approval or rejection thereof back to the recipient device 105 substantially in real time. Generally, the purchase request is transmitted to the administrative system 130 over the network 160 as soon as the recipient completes the purchase request on his communication device 105 and indicates that the request is ready for processing (such as by pressing a “send” or “request approval” button on a touch screen). As a result, approval or rejection of a purchase request is substantially immediate and is provided by the administrative system to the recipient device 105 automatically in response to the administrative system 130 determining whether or not the purchase details included in the request satisfy the conditions and rules that have been previously set by the payor.

It will be appreciated that the immediacy of such feedback may be delayed by network issues, such as distances between servers, outages, latency, or mobile reception, but generally the purchase request response (i.e., approval or rejection) occurs substantially in real time after the recipient has chosen to have the communication device 105 send the purchase request. Additionally, the purchase request approval process is preferably performed by the processor 136 in cooperation with other administrator system components in accordance with programmed instructions. More specifically, the purchase request approval process occurs automatically and without the necessity of human intervention and decision making and, as a result, delays within the payment system 100 are conveniently minimized.

It will be appreciated that the payor may add funds, remove funds, change conditions, and add or delete recipients at any time, provided that such changes do not cause the account to become overdrawn. Such flexibility provides the payor with the ability to address changes in the recipient's financial situation conveniently and almost immediately. Additionally, since the recipient accesses the funds on a per-transaction basis and without cash, credit cards, or checks, the funds are advantageously protected from fraud, theft, or loss. If the recipient misplaces his smartphone or access device, the account remains secure since funds may not generally be accessed without use of recipient identification information and a password, unless the payor elects otherwise.

Within the payment system 100 of the present embodiment, private information related to the recipient and his purchases also remains secure. By way of example, if the recipient makes a payment associated with a recipient account number (e.g., a utility bill or medical invoice), the account number is not transferred back to the payor. In the case of a medical invoice, details about the medical history of the recipient are not provided back to the payor or even the administrator. As a result, the privacy of the recipient is preserved by the payment system 100.

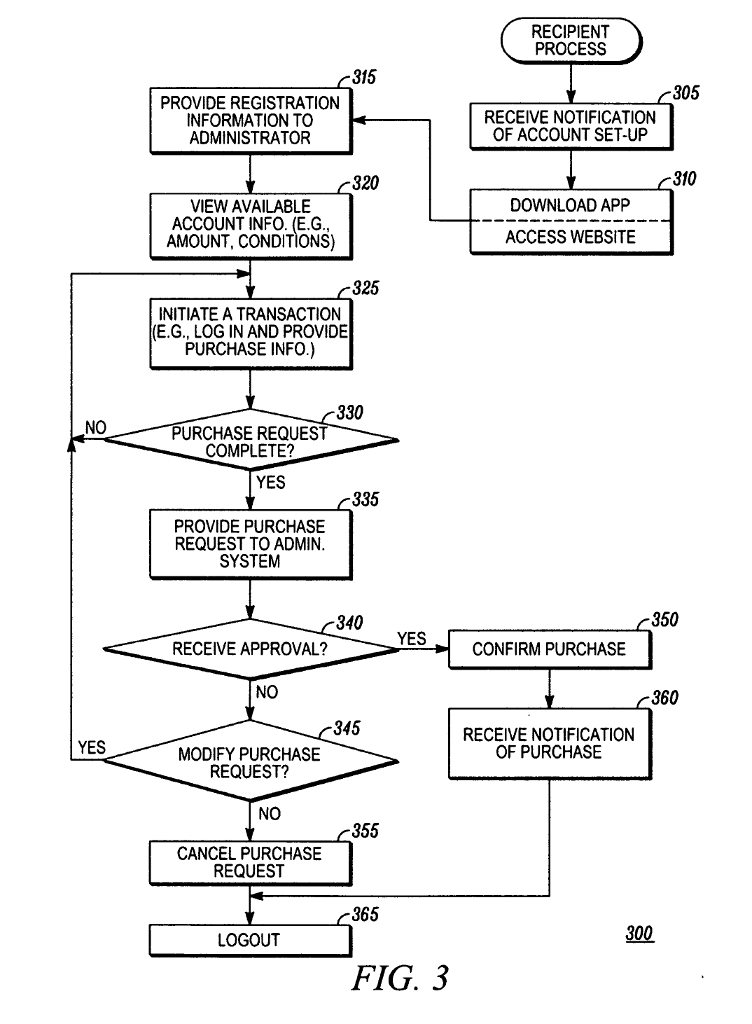

FIG. 3 illustrates a recipient process 300 performed by the payment system 100. At step 305, the recipient/dependent user receives a notification from the administrator that funds have been deposited for his use by a third party payor. Preferably, the notification is sent to the recipient device 105 by the administrator system 130 for viewing by the recipient. The notification sent to the recipient device 105 may also include instructions for accessing the account and a temporary password for authentication. Alternatively, notification could merely comprise a telephone call or other type of communication from the payor or administrator. If the recipient has not used the payment system 100 before, he may proceed, at step 310, to download an administrator app for use with a communication device 105 (FIG. 1), such as a smartphone 120, or access the administrator website from a computer 110 or other network device.

The recipient may also, at step 315, register with the administrator system 130 (FIG. 1) by, for example, setting up user identification information, a password, and notification instructions indicating how he prefers to receive alerts within the payment system 100. Alerts could be provided in any number of convenient ways, such as within the administrator app, by email, by text, or by telephone.

Next, at step 320, the recipient may view available account information, including any conditions set up by the payor for his use of the account funds and the amount available to spend. As mentioned hereinabove, the conditions may include prohibitions on certain categories of goods, services, or merchants, prohibitions on cash withdrawals, approved categories of goods, services, or merchants, date ranges within which purchases are allowed, caps on the amount of spending per day or overall, or any other conditions that the payor has requested.

The recipient then, at step 325, initiates a transaction within the payment system 100. According to an embodiment of the present invention, the recipient may, for instance, make an online purchase, a purchase by telephone, or a purchase at a merchant's place of business, but regardless of the type of purchase, the transaction is initiated by the recipient rather than the merchant. This is generally accomplished by the recipient using a device 105 to open an administrator app or to navigate to the administrator website, after which the recipient enters his credentials. The recipient then specifies the goods or services he would like to purchase.

This could be done in any number of ways pursuant to the present invention. For example, the recipient could choose an approved category (e.g., utilities) then select his provider and input his account number and the amount to be paid. Alternatively, the recipient could use a mobile communication device 105 to scan a barcode, QR code, or serial number on a product, take a photo of the product, or enter other product identification information (e.g., brand and product name) into a provided field of the administrator app or website. The recipient may, in this manner, scan or enter product information, which may include price, for as many products as he wishes to purchase.

When, at step 330, the recipient has entered all required information related to his purchase request and indicated that the request is ready for approval, such as by selecting a “completed,” “all done,” or similar button within an app or via a website, the recipient's device 105 (FIG. 1) communicates with the administrator system 130, at step 335, and provides the purchase request thereto. The administrator system 130 compares the products, services, and other information related to the purchase with the conditions that have been set by the payor and that are stored in the memory 134. If the conditions are satisfied (including the condition that sufficient funds are available), the purchase is approved, and the recipient is notified, at step 340, by the administrator system 130. The notification may, for example, comprise an alert displayed within an app, a text, or an email sent to the recipient device 105 from the administrator.

In accordance with an embodiment of the present invention, the transaction is approved prior to and without merchant involvement. As a result, sensitive recipient information, payor information, and other account information remains private and is not shared with the merchant or any merchant representatives. The payment system 100 is therefore more secure than using checks, credit cards, or cash, which may be lost or stolen relatively easily.

If the purchase conditions set by the payee are not satisfied, the recipient is notified, at step 340, that the purchase is not approved. Preferably, the administrator system 130 sends an alert to the recipient device 105 to notify the recipient that the purchase is not approved and, optionally, information indicative of the reason why. If some of the products or services included in the purchase request are approved for purchase, the recipient may proceed with the purchase of any approved products. For example, the recipient may, at step 345, modify his purchase request by deleting the unapproved product from the purchase request and sending the modified request back to the administrator system 130 for approval.

At step 345, the recipient could instead decline to proceed with the purchase, in which case the proposed transaction is canceled, at step 355, and a communication is sent from the recipient device 105 to the administrator system 130 to indicate that the recipient has withdrawn the purchase request. It will be appreciated that the payment system 100 as described herein has the added advantage that information related to unapproved purchase requests is not forwarded to the merchant or service provider at all. As a result, the recipient is spared the embarrassment that could occur, for instance, in a situation in which a merchant declines a credit card or refuses to accept a check.

Within the payment system 100, the administrator could, upon receiving a purchase request from the recipient that falls outside the approved purchase parameters, notify the payor and offer the choice of amending the conditions to permit the purchase, allowing a one-time exception to the conditions, confirming that the purchase should be declined, or making more funds available (in the event that the purchase has been declined because of insufficient funds). In such circumstances, a request for an exception could be provided to the payor by the administrator automatically, at the request of the recipient, or pursuant to instructions provided by the payor, depending upon the preferences of the payor. It will be appreciated that, in accordance with other embodiments of the present invention, the payment system 100 may conveniently offer the flexibility to permit payors to designate conditions, notifications, requests, and other processes that are unique for each situation, for each recipient, and for each payor.

For example, a payor could set up a recipient account for a dependent child in a manner that permits the child to purchase school-related items, up to a certain amount, only during dates at the beginning of a school term. The account might additionally permit purchases at a school cafeteria without limit and, with prior approval, repair and maintenance costs for a vehicle owned by the child or payor.

Account preferences for an adult family member could, if the payor desires, be structured quite differently. If the payor opts to grant an adult recipient more autonomy and privacy, he may, for example, set conditions that specify general categories of approved purchases, general categories of unapproved purchases, and a cap on spending, and then request to be notified after each approved purchase of only the date and amount that has been disbursed from his account. As mentioned hereinabove, the payor may even opt to set no conditions upon the recipient's use of the available funds.

Referring back to FIG. 3, once the recipient has received a notification that the purchase is approved, the recipient may optionally be prompted to confirm the transaction, at step 350, subsequent to which the recipient device 105 may receive, at step 360, a purchase confirmation notification from the administrator system 130. The notification preferably includes the date, the merchant identification, the purchase amount, and details about the transaction, such as a list of purchased products. If the purchase has been made online or perhaps via a kiosk or network portal at a retail location, the recipient then accepts delivery of the products (e.g., directly from the merchant location or through the mail). In the case of services, such as payment of a utility bill, the recipient may also receive a separate payment confirmation from the merchant, although such a confirmation is optional and not necessarily performed by processes within the payment system 100.

Once an approved purchase has been completed, the recipient may, at step 365, disconnect from the administrator system 130 (FIG. 1) by logging out. Alternatively, the administrator system 130 may disconnect from the recipient device 105 automatically after a certain period of time has elapsed or immediately after the transaction is concluded. As will be described in greater detail hereinbelow, the administrator system 130 notifies the merchant of the purchase and authorizes the release of funds to the merchant so that the recipient can receive the products or services that have been purchased via the payment system 100.

Optionally, the payment system 100 may provide a process for a recipient to review and request changes to disbursement conditions prior to initiating a purchase transaction. In accordance with an embodiment of the present invention, the recipient could view the conditions set by the payor after registering with the administrator system 130 and input relevant information, such as a change in circumstances or preference for a particular merchant, to be sent to the administrator system 130 via the recipient device 105. Upon receiving the information from the recipient, the administrator system 130 could then forward the request to the payor in the format specified in the payor's notification preferences. The payor could then confirm the conditions, e.g., deny the request or change the conditions by logging into the administrator system 130 and providing the changed conditions.

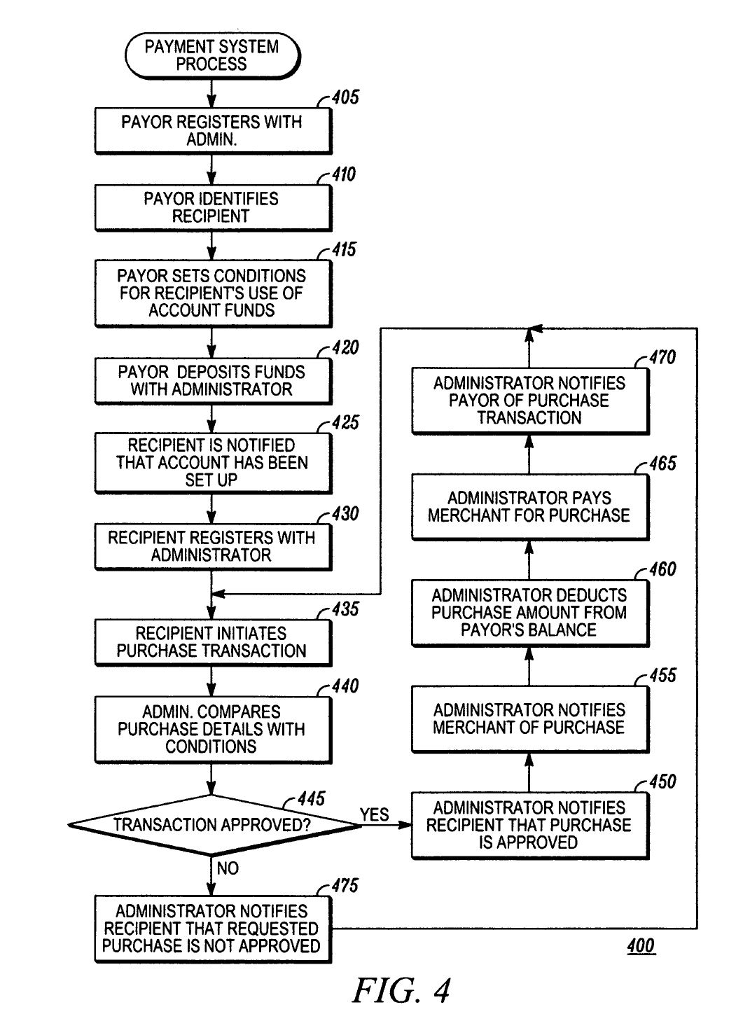

Referring next to FIG. 4, a flowchart depicts general processes that occur in the payment system 100 (FIG. 1) in accordance with an embodiment of the present invention. Before any purchases are made by a recipient, the payor who is providing the funds sets up, at step 405, an account with the administrator. It is understood that the setup process may occur in many different ways, such as by telephone, in person, online, or via an app available to the payor. In accordance with one embodiment of the present invention, the payor installs an app on a mobile communication device 150 (FIG. 1). When, in the present example, the app is opened by the payor, the payor is presented with the option of registering with the administrator. If he selects to do so, the payor inputs information such as a user identification code and a password which allows him to securely access his account. The administrator system 130 stores the payor identification information in the memory 134, which could be local or remote, and which may, for instance, be physically located in a computer or other device for storing information. The memory 134 may be used to store a payment database 140, which also stores information related to the accounts of other payors who wish to utilize the services of the payment system 100.

The administrator system 130 additionally receives and stores payor preference information, such as contact information and notification preferences, which could include information designating situations in which the payor wishes to receive alerts and notifications from the payment system 100, the types of alerts and notifications he wishes to receive, and the method (e.g., email, text, telephone call) by which he is to be alerted and notified. The administrator system 130 additionally receives, at step 410, information from the payor identifying one or more recipients who are permitted to access funds provided by the payor. For each recipient, the payor further provides, at step 415, specific information about how, where, and when each recipient may spend the funds and the amount of money that is available to each recipient.

By way of example, the payor may choose specific merchants or categories of merchants from which the recipient may purchase goods and services and/or specific goods and services or categories of goods and services that may be purchased. The recipient's access to the account funds may be limited to specific dates or ranges of dates or capped at a certain amount. The payor's options for specifying how the money in the account is spent are limited only by the ability of the administrator system 130 to determine whether conditions set by the payor have been satisfied by a requested purchase transaction, and it is understood that such limitations may be bypassed by a payor's request to approve each recipient purchase in advance.

Generally, however, the advantages and conveniences of the payment system 100 are maximized by storing conditions that are specific enough for the administrator system 130 to determine whether conditions have been satisfied by a purchase request from a recipient without additional input from the payor or other human operator. As a result, the administrator system 130 may generally accept or decline a requested purchase transaction automatically in accordance with processor programming, which minimizes delays and maximizes efficiency within the payment system 100.

Once the payor has designated a recipient and defined conditions that are to be met for recipient purchases to be approved, the payor deposits, at step 420, funds in the account using any generally accepted method of payment. The payor may, for example, provide funds by check, credit card, debit card, transfers from a bank account, or in cash. The funds are processed by the administrator, and the processor 136 stores information indicative of the amount of funds that are available to each recipient designated by the payor. Funds may be thereafter added to the payor's account as needed or according to a schedule requested by the payor or required by the administrator.

When the payor setup process for a recipient is complete, the payor or the administrator communicates, at step 425, with the recipient to register the recipient with the payment system 100. Preferably, the recipient accesses, at step 430, the administrator system 130 to set up a user identification code and a password or other means (e.g., voice print or fingerprint) by which the recipient may be authenticated. Alternatively, the registration process for the recipient could be omitted entirely, and the recipient could simply be provided with authentication information generated by the administrator system 130 or the payor, and such authentication information could be used by the recipient during purchase transactions.

Preferably, the purchase transaction process is begun when, at step 435, the recipient logs in and initiates a transaction, i.e., when the administrator system 130 receives authentication information identifying a recipient and information related to goods or services that the recipient wishes to purchase. In accordance with an embodiment of the present invention, once a recipient has logged in to an app or website to access the administrator system 130, the recipient may select a merchant from a list of pre-approved merchants or service providers. If the purchase is online, the administrator system 130 may redirect the recipient to a website operated by the selected merchant in order to choose merchandise or services for purchase. Alternatively, once the recipient has selected an approved merchant, the recipient may provide product information to the administrator system 130 using the recipient device 105 to scan a barcode or QR code or to type in a product description and price. The recipient thereafter confirms his desire to purchase the products or services, such as by sending a purchase request to the administrator.

As mentioned above, the administrator system 130 receives the purchase request and compares, at step 440, the information included in the request to the conditions set by the payor to determine whether the purchase request is approved, partially approved, or declined. If, at step 445, the purchase transaction is not approved by the administrator, the administrator notifies, at step 475, the recipient that the purchase is not authorized.

If, on the other hand, the purchase is approved, at step 445, the administrator system 130 notifies the recipient, at step 450, and the payor, that the purchase has been approved. The administrator also deducts, at step 460, the purchase amount from the payor's account. Additionally, the administrator system 130 notifies, at step 455, the merchant of the purchase and authorizes the release of funds to the merchant in the appropriate amount, at step 465.

Preferably, the administrator notification to the merchant includes information identifying the recipient and the goods or services that are to be provided to the recipient. The notification may, for example, include the recipient name so that the recipient can show identification to the merchant to collect the purchased items or perhaps a confirmation code that the recipient presents to the merchant in order to receive the items. The notification could instead provide the name and address of the recipient to enable the merchant to mail the purchased goods to the recipient.

If the recipient has made a purchase using the payment system 100 while in a merchant's retail location, the approval notification provided to the recipient may, by way of example, include instructions to request that the merchant view incoming notifications Regardless of the method used to notify the recipient and the merchant, it is anticipated that the notifications communicated to both parties by the administrator system 130 include information sufficient to enable the recipient to receive the purchased goods or services from the merchant.

One of ordinary skill in the art will appreciate that the steps depicted in the flowchart of FIG. 4 need not always occur in the illustrated order. If, for instance, a purchase transaction is approved, notifications are provided to the recipient, the merchant, and the payor. Although it is preferable that the notifications to the merchant and the purchasing recipient occur relatively soon after approval so that the goods and services may be transferred to the recipient, the notification to the payor need not be communicated at the same time. Instead, the payor may be notified according to preferences set by the payor during account setup with the administrator or according to a predetermined schedule set by the administrator.

It will be further appreciated that notifications other than those shown in FIG. 4 could occur within the payment system 100. By way of example, the payor may be notified in the event that a purchase transaction is declined by the administrator. Such notifications could be useful to the payor in determining whether conditions should be changed to better accommodate the recipient's financial needs. Other notifications could include notifications regarding fees charged by the administrator for use of the payment system 100. The administrator could, for instance, charge a fee payable by any or all of the recipient, payor, and merchant.

Referring back to FIG. 1, the administrator system 130 communicates with merchants via a merchant system 155 or device, such as a computer, a smartphone, a tablet device, a mobile phone, or other network device. In accordance with the present invention, the administrator makes payment arrangements with prospective merchants that are to be included in the payment system 100. If a merchant has a bank account, the administrator may, for instance, arrange to wire money directly to the merchant's account when a purchase transaction by a recipient is approved. Alternatively, the administrator may deposit funds directly with a merchant in advance of any purchase transactions, and the merchant may hold the funds in escrow until receiving a purchase notification from the administrator system 130. The merchant may additionally specify the currency in which payments are to be made. By way of example, the merchant may require that payment be made in dollars or in the currency of the country in which the merchant is located. If the merchant chooses to be paid in a currency different from that deposited by the payor, the administrator system 130 preferably converts the funds according to the exchange rate at the time of the purchase or another time agreed upon by both parties.

A primary advantage of the payment system 100 described herein is that recipients are able to make purchases and merchants are able to receive payment without regard to the financial infrastructures available to the recipient and merchant. As a result, money may be provided to dependent family members and friends even if they are unable to open a bank account or use a credit card. The payment system 100 therefore provides a convenient and safe way to financially support dependents who reside in financially unstable regions or in regions distant from the payor.

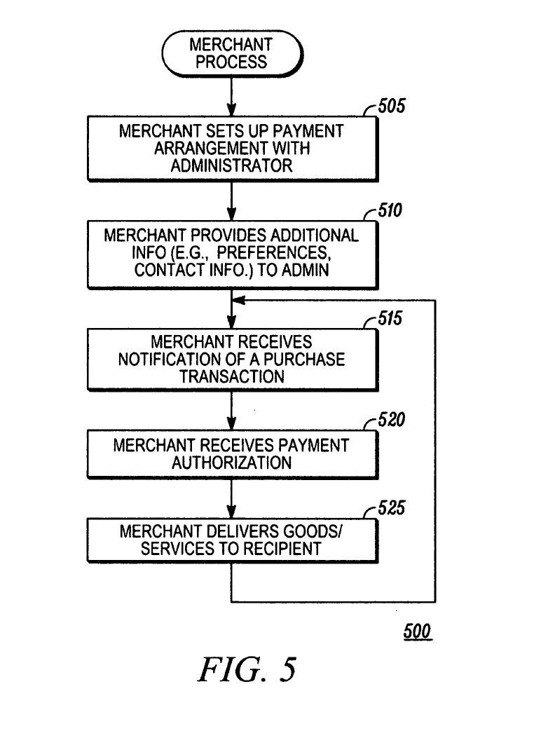

FIG. 5 depicts merchant processes 500 that may be performed in the payment system 100 of the present embodiment. As mentioned briefly above, the administrator of the payment system 100 preferably sets up payment arrangements with merchants before a recipient purchases goods or services from such merchants using funds from the payor's account. Many countries and regions of the world have financial ecosystems that are sparsely developed, and banks may be largely non-existent. As a result, cash purchases or barters are often the primary methods of paying for items and services. In many such countries, however, mobile phones are widely distributed and used, and opportunities exist to establish a payment system, such as that described herein in accordance with an embodiment of the present invention, that can easily and safely use mobile phones or other network devices to facilitate purchase transactions.

Within the payment system 100, the administrator contacts merchants and vendors who offer goods and services within a geographic region in which the dependent/recipient lives or shops. If a merchant would like to be included in the payment system 100, the administrator and the merchant negotiate payment arrangements, at step 505 (FIG. 5). If the merchant has a bank account, for instance, the administrator may arrange to deposit funds directly to the bank account when a recipient makes a purchase from the merchant in the payment system 100. If the merchant accepts credit cards or debit cards, the administrator may instead arrange to have a credit or debit card held by the administrator charged or debited, respectively, by the merchant when a purchase is made. Alternatively, if the administrator has a local representative, the representative may simply pay the merchant in cash when a recipient buys from the merchant using the payment system 100.

It will be appreciated that the administrator may, rather than paying for each merchant transaction individually, deposit funds in advance with the merchant. This may be done in any manner of accepted ways, such as by providing the merchant with a prepaid debit card, depositing funds in a merchant bank account, or providing the merchant with an upfront cash payment that is held in escrow by the merchant.

The merchant provides, at step 510, merchant information to the administrator system 130 (FIG. 1) for storage in the memory 134. The merchant information preferably includes merchant identification information, merchant contact information, notification preferences (e.g., text, email, app, website, or telephone), payment details, and (if funds have been prepaid) account balance, all of which may be stored in a database 142 within the administrator system 130.

When the administrator system 130 approves a purchase transaction requested by a recipient, the administrator system 130, preferably via the processor 136 and the communication device 138, provides a purchase notification to the merchant system 155, at step 515. The purchase notification is transmitted by the administrative system 130 to the merchant system 155 according to merchant preferences that have been stored in the database 142. The purchase notification identifies the purchase price, the items or services, and the recipient, perhaps by name or by a confirmation number that must be presented by the recipient, and any other details relevant to the transaction.

Additionally, the administrator authorizes the release of funds to the merchant, who may then charge an administrator credit card or debit card, access funds deposited by the administrator into the merchant's bank account, or otherwise access funds already in his control, such as when the merchant has been prepaid by the administrator. The merchant system 155 may receive, at step 520, a payment authorization as a part of the purchase notification or in a separate communication. If payment arrangements between the administrator and the merchant specify that the administrator is to pay the merchant directly for each purchase, the payment authorization may simply provide confirmation that the administrator has deposited the appropriate amount of money into a merchant account rather than authorizing access to funds over which the merchant already has control. It is anticipated that the recipient then contacts the merchant to arrange delivery of the goods or services, at step 525.

The merchant system 155 can be, for example, a computer, a mobile telephone, a smartphone, or another type of device capable of receiving communications from the administrator system 130. The merchant may also use the merchant system 155 to access details of previous purchases and to communicate changes in contact information or preferences to the administrator system 130.

Payments to the merchant from the administrator may be conveniently provided even in the absence of financial systems, such as banking or credit card infrastructures. Therefore, the payment system 100 described herein has several notable advantages over existing payment systems. First, the payment system 100 can be used in financially unstable regions and geographic locations that are distant from both the administrator and the payor. Additionally, in situations in which the administrator has established a pre-paid balance with a merchant, merchant access to the funds may occur immediately after notification of a purchase transaction. The merchant does not have to be concerned that a payment by a purchaser will be declined by a credit card company or that a purchaser check will bounce, and there are no delays in the merchant's ability to access the payment. Furthermore, since the purchase transaction generally occurs electronically, neither the recipient nor the merchant need worry about theft or loss of the purchase amount.

The payment system 100 of the present invention is advantageously structured such that a payor, i.e., a person providing funds to anther person, has as much or as little control over the funds being spent as he prefers. The payor may place conditions on the use of the money by the recipient, and the administrator determines whether the recipient's proposed purchase has met the conditions specified by the payor before funds are withdrawn from the payor's account. As a result, the payor can be assured that money he is providing will be spent according to his wishes, and he doesn't have to worry that the money will be lost, stolen, or spent impulsively or unwisely.

Thus, it can be seen that there has been provided a payment system in which a financial provider can easily, safely, and quickly transfer funds to a dependent located in a geographical location where financial infrastructures, such as banking and credit card infrastructures, are absent. The payment system, furthermore, prevents the dependent recipient from spending the financial provider's funds in unapproved ways and also protects payments from loss or theft.

While at least one exemplary embodiment has been presented in the foregoing detailed description of the invention, it should be appreciated that a vast number of variations exist, including a vast number of acceptable dimensions. In addition, in this document, the terms “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “includes . . . a” does not, without more constraints, preclude the existence of additional identical elements in the process, method, article, or apparatus that comprises the element.

It should further be appreciated that the exemplary embodiment is only an example, and is not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A payment system for processing a purchase requested by a recipient and funded by a payor, the payment system comprising:
a memory for storing account balance information associated with an account funded by the payor and purchase conditions set by the payor;
a communication device for receiving a purchase request from the recipient, wherein the purchase request is indicative of the purchase that the recipient desires to make; and
a processor coupled to the memory and the communication device for determining whether the purchase request meets the purchase conditions set by the payor and for generating a purchase approval notification when the purchase request satisfies the purchase conditions;
wherein the communication device transmits the purchase approval notification to the recipient; and
wherein the communication device, subsequent to determining that the purchase request meets the purchase conditions, communicates with a merchant associated with the purchase request to notify the merchant of the purchase and to authorize payment to the merchant for the purchase.

2. The payment system of claim 1, wherein the processor generates and sends to the recipient a purchase rejection notification in response to a determination that the purchase request does not satisfy the purchase conditions set by the payor.

3. The payment system of claim 2, wherein the merchant is notified of the purchase only in response to a determination that the purchase request meets the purchase conditions.

4. The payment system of claim 1, wherein, once the account funded by the payor is established, the processor determines whether the purchase request meets the purchase conditions automatically and without further human intervention.

5. The payment system of claim 1, wherein the purchase request includes information identifying the merchant from which the recipient desires to purchase.

6. The payment system of claim 5, wherein the purchase conditions include a merchant list indicative of at least one approved merchant from which the recipient may purchase using the funds associated with the account, and wherein the processor determines that the merchant is included in the merchant list prior to transmitting the purchase approval notification.

7. The payment system of claim 1, wherein the purchase request includes information identifying merchandise that the recipient desires to purchase.

8. The payment system of claim 7, wherein the purchase conditions include merchandise categories indicative of at least one approved type of merchandise that may be purchased by the recipient, and wherein the processor determines that the merchandise identified by the purchase request is included in the merchandise categories prior to transmitting the purchase approval notification.

9. The payment system of claim 1, wherein the communication device is capable of coupling to a communication network to receive the purchase request, to transmit the purchase approval notification, and to communicate with the merchant.

10. The payment system of claim 9, further comprising:
a recipient device for coupling to the communication network to send the purchase request and to receive the purchase approval notification; and
a merchant device for coupling to the communication network to receive communications associated with the purchase once the purchase has been approved in accordance with the purchaser conditions.

11. The payment system of claim 1, wherein funds equivalent to the payment to the merchant are deducted from the account in response to determining that the purchase request meets the purchase conditions.

12. A payment system for processing a purchase requested by a recipient and funded by a payor, the payment system comprising:
a memory for storing account balance information associated with an account funded by the payor and purchase conditions set by the payor;
a communication device for coupling to a network to receive a purchase request from a recipient device associated with the recipient, wherein the purchase request is indicative of the purchase that the recipient desires to make; and
a processor coupled to the memory and the communication device for automatically determining whether the purchase request meets the purchase conditions set by the payor and for generating a purchase approval notification when the purchase request satisfies the purchase conditions;
wherein the communication device automatically transmits the purchase approval notification to the recipient device over the network in response to approving the purchase request; and
wherein the communication device automatically transmits a purchase notification over the network to a merchant device associated with a merchant from which the recipient desires to make the purchase, wherein the purchase notification is transmitted only in response to approving the purchase request.

13. The payment system of claim 12, wherein the communication device additionally transmits a payment authorization notification to the merchant device in response to approving the purchase request.

14. The payment system of claim 12, wherein the processor determines whether the purchase request meets the purchase conditions automatically and substantially in real time.

15. A method within a payment system for processing a purchase requested by a recipient and funded by a payor, wherein the payment system comprises a memory for storing account information associated with an account funded by the payor, a communication device for transmitting and receiving notifications associated with the purchase, and a processor for approving or rejecting the use of payor funds in association with the purchase, the method comprising the steps of:
receiving, from the payor, the purchase conditions and storing them in the memory;
the communication device receiving a purchase request from a recipient device;
the processor comparing information included in the purchase request with the purchase conditions stored in the memory;
the processor determining whether the purchase request satisfies the purchase conditions;
the communication device transmitting a purchase approval notification to the recipient device in response to the processor determining that the purchase request satisfies the purchase conditions; and
the communication device notifying a merchant associated with the purchase request of the purchase in response to the processor determining that the purchase request satisfies the purchase conditions.

16. The method of claim 15, further comprising the step of:
the communication device authorizing payment to the merchant for the purchase in response to the processor determining that the purchase request satisfies the purchase conditions.

17. The method of claim 16, further comprising the steps of:
the communication device notifying the payor that funds equivalent to the payment to the merchant have been deducted from the account in response to determining that the purchase request meets the purchase conditions.

18. The method of claim 17, wherein the steps of determining whether the purchase request satisfies the purchase condition and transmitting the purchase approval notification occur substantially in real time.

19. The method of claim 18, further comprising the step of:
the communication device, subsequent to transmitting the purchase approval notification, receiving a purchase confirmation from the recipient, wherein the step of notifying the merchant of the purchase occurs in response to receiving the purchase confirmation.

20. The method of claim 18, further comprising the step of:
the communication device transmitting, in response to determining that the purchase request does not satisfy the purchase conditions, a purchase rejection notification to the recipient.
